(19) United States
(12) Patent Application Publication
(10) Pub. No.: US 2026/0251199 A1
(43) Pub. Date: Aug. 27, 2026

(54) TUNED MASS DAMPER INERTER AND PARAMETER DESIGN METHOD THEREFOR

(71) Applicant: SOUTH CHINA UNIVERSITY OF TECHNOLOGY, Guangzhou City (CN)

(72) Inventors: Hongwei MA, Guangzhou City (CN); Yutang ZENG, Guangzhou City (CN); Jinyi ZHU, Guangzhou City (CN); Pengyuan WANG, Guangzhou City (CN)

(73) Assignee: SOUTH CHINA UNIVERSITY OF TECHNOLOGY, Guangzhou City (CN)

(21) Appl. No.: 19/549,328

(22) Filed: Feb. 25, 2026

(30) Foreign Application Priority Data
Feb. 26, 2025 (CN) 202510214669.9

(51) Int. Cl. F16F 15/02; F16F 9/53

(52) U.S. Cl. CPC F16F 15/022; F16F 9/535; F16F 2222/08; F16F 2228/06; F16F 2230/0052; F16F 2232/06

(57) ABSTRACT

A tuned mass damper inerter includes a counterweight, a first guide rod, a first rigid spring, a first intermediate plate, a damper element, and an inerter element. The counterweight is slidably connected to a floor slab. The first rigid spring is sleeved over the first guide rod, and two ends of the first rigid spring abut against the counterweight and one side of the first intermediate plate, respectively. One end of the damper element and one end of the inerter element are both fixedly connected to the other side of the first intermediate plate, and the other end of the damper element and the other end of the inerter element are both fixedly connected to a main structure of the floor slab. A sliding direction of the counterweight, the first guide rod, the damper element, and the inerter element are parallel to each other.

### CROSS-REFERENCE TO RELATED APPLICATION

This application claims priority to and the benefit of Chinese patent application No. 202510214669.9, filed Feb. 26, 2025, the contents of which are incorporated by reference herein in their entirety.

### TECHNICAL FIELD

The present disclosure relates to the technical field of building vibration mitigation, and in particular, to a tuned mass damper inerter and a parameter design method therefor.

### BACKGROUND

Modern buildings, characterized by relatively large height-to-width ratios, feature more flexible structural systems with longer natural vibration periods. Under sudden, random, and destructive external excitations, such structures are prone to property damage and personal injury. Therefore, it is necessary to adopt vibration mitigating structural control measures to enhance the vibration resistance of the structures.

A tuned mass damper (TMD) is a vibration mitigation substructure commonly attached to a structure in the building field, and its mass block is typically connected to a building structure via a spring and a damper element. The weight of the TMD is determined by a mass ratio (i.e., the mass of the mass block of the TMD divided by the structural mass). Generally, a larger mass ratio results in better vibration absorption effect of the damper element.

In the prior art, the usage scenarios of TMDs in the building field are primarily limited by the tuned mass. An excessively large tuned mass may occupy too much mounting space, leading to difficulties in design and construction as well as increased building costs. Given the current trend toward large-area and large-mass building structures, traditional small-tonnage TMDs can hardly achieve the vibration mitigation effect required for the main structures of such constructions.

### SUMMARY

In view of the problems existing in the prior art, an objective of the present disclosure is to provide a tuned mass damper inerter and a parameter design method therefor, which can achieve lightweight control of natural vibration of building structures.

To achieve the above objective, the present disclosure adopts the following technical solutions:

A tuned mass damper inerter includes a counterweight, a first guide rod, first rigid springs, a first intermediate plate, a damper element, and an inerter element. The counterweight is slidably connected to a floor slab. Both ends of the first guide rod are respectively connected to the counterweight and one side of a first base plate. The first rigid springs are sleeved over the first guide rod, and two ends of the first rigid springs abut against the counterweight and one side of the first intermediate plate, respectively. One end of the damper element and one end of the inerter element are both fixedly connected to the other side of the first intermediate plate, and the other end of the damper element and the other end of the inerter element are both fixedly connected to the floor slab. The sliding direction of the counterweight, the first guide rod, the damper element, and the inerter element are parallel to each other. With this configuration, the damper element provides a damping force for the sliding motion of the counterweight, and the mass coefficient of the inerter element can significantly increase the equivalent mass of the system. Therefore, the arrangement of the inerter element amplifies the mass of the counterweight, allowing the mass of the counterweight to be reduced under the same vibration mitigation effect, thereby achieving lightweight control. The first rigid springs stabilize the motion of the counterweight, leading to more stable response of the damper element and consequently more stable vibration mitigation effect of the tuned mass damper inerter.

Preferably, the damper element is a magnetorheological damping element. The piston rod end of the magnetorheological damping element is fixedly connected to the first intermediate plate, while the cylinder body of the magnetorheological damping element is fixedly connected to the main structure of the floor slab. The damping magnitude of the magnetorheological damping element is adjustable. With this configuration, the magnetorheological damping element features a simple structure, compact size, fast response, and a wide dynamic range, which helps enhance the vibration mitigation effect of the tuned mass damper inerter and expand its application scenarios.

Preferably, the inerter element is a ball screw. The shaft end of the ball screw is fixedly connected to the first intermediate plate, while a rotating nut of the ball screw is fixedly connected to the main structure of the floor slab. With this configuration, the ball screw offers advantages such as a stable structure, high transmission efficiency, and ease of control, with convenient parameter adjustment.

Preferably, the damper element and the inerter element are symmetrically arranged on both sides of the first guide rod. With this configuration, the balance and stability of the tuned mass damper inerter can be further improved.

Preferably, the first guide rod passes through the first intermediate plate and is provided with the first base plate at a tail end thereof. The first intermediate plate is located between the counterweight and the first base plate. The first rigid springs are arranged between the first intermediate plate and the counterweight and between the first intermediate plate and the first base plate. With this configuration, the forces on the two ends of the first intermediate plate are more balanced, and the motion amplitude of the first intermediate plate can be controlled, so that the motion of the counterweight can be transmitted to the damper element and the inerter element more stably, thereby allowing the damper element to respond to the vibration of the main structure more stably. On the one hand, the impact of the counterweight on the damper element and the inerter element can be reduced, and on the other hand, the vibration mitigation effect can be enhanced.

Preferably, a linear round guide rail passes through the middle of the first intermediate plate, and is sleeved over and slidably connected to the first guide rod. With this configuration, the motion of the first intermediate plate is smoother and more stable, which is conducive to increasing the response speed of the tuned mass damper inerter.

Preferably, a second guide rod is disposed on one side of the first guide rod. Second rigid springs are sleeved over the second guide rod. The second rigid springs are parallel to the first rigid springs, and both ends of the second rigid springs abut against the counterweight and the floor slab, respectively. With this configuration, the motion of the counterweight is more stable, and the motion stability of the tuned mass damper inerter can be improved. Therefore, this design can improve the vibration control capability of the tuned mass damper inerter to the main structure.

Preferably, a second intermediate plate passes through the second guide rod. A second base plate is disposed at a tail end of the second guide rod. The second rigid springs are arranged between the second intermediate plate and the counterweight and between the second intermediate plate and the second base plate. With this configuration, the motion stability of the counterweight is further improved.

Preferably, the first rigid spring between the first intermediate plate and the counterweight and the first rigid spring between the first intermediate plate and the first base plate are the same in total stiffness, length, and deformation amount. The second rigid spring between the second intermediate plate and the counterweight and the second rigid spring between the second intermediate plate and the second base plate are the same in total stiffness, length, and deformation amount. The first rigid springs mainly move in cooperation with the parallel-connected assembly of the inerter element and the damper element, and produces a resonance effect. In this case, the motion phase of the parallel-connected assembly will be nearly opposite to that of the first rigid springs, so that the displacement amplitude of the parallel-connected assembly is greater than that of the counterweight. That is, it is conducive to generating greater damping under a small displacement of the damper element. The second rigid springs between the second intermediate plate and the counterweight and between the second intermediate plate and the second base plate are the same in total stiffness, length, and deformation amount. The second rigid springs mainly play a role of tuning, so that the natural vibration period of the counterweight is close to that of the main structure. By using the structure with rigid springs on both sides, the corresponding stiffness can be kept unchanged in the tension and compression states, which makes the actual structure closer to the mechanical principle. Meanwhile, the motion stability of the first intermediate plate and the counterweight will be enhanced, and the vibration control capability of the tuned mass damper inerter to the main structure will be better.

A parameter design method for a tuned mass damper inerter includes the following steps:
step 1, pre-analyzing a main structure of a floor slab to obtain modal and vibration mode results and determine a mounting position of the tuned mass damper inerter;
step 2, after determining the mounting position, establishing a kinematic equation, deriving a displacement response transfer function of the main structure from the kinematic equation, and then establishing an optimization equation with the H₂ norm l of the displacement response transfer function of the main structure as an optimization objective;
where the kinematic equation is expressed as:

$$\\ {MX}^{″} + {CX}^{′} + KX = - {M}_{R} {X}_{g}^{″} ;$$

and
the displacement response transfer function is expressed as:

$$\\ H ( ω ) = {{C}_{s} ( i ω I - A )}^{- 1} E ;$$

where

$$\\ A = [ \begin{matrix}0 & I \\ - {M}^{- 1} K & - {M}^{- 1} C\end{matrix} ] ; E = [ \begin{matrix}0 \\ - {M}^{- 1} {M}_{R}\end{matrix} ] ;$$

and

$$\\ {C}_{s} = [ \begin{matrix}{l}_{N + 2 n} & {0}_{N + 2 n}\end{matrix} ] ;$$

where I represents a unit matrix; M represents a mass matrix attached with tuned mass and inertance; K represents a stiffness matrix; C represents a damping matrix; M_{R} represents a mass matrix only attached with tuned mass; A represents a state matrix to describe dynamic characteristics of a system; E represents an input matrix to describe the effect of an input on a state; and Cs represents an output matrix to describe the contribution of the state to an output;
step 3, determining the optimization objective/according to requirements, and with given value ranges of a tuned mass ratio μₜ and a damping ratio ζᵢₙ, achieving the parameter optimization of the tuned mass damper inerter via step-by-step parameter scanning, wherein the tuned mass damper inerter is a rotational inertia double-tuned mass damper (RIDTMD);

### The Optimization Equation is Expressed as:

$$\\ l = {‖ H ‖}_{2} = {‖ {{C}_{s} ( i ω - A )}^{- 1} E ‖}_{2} ;$$

$$\\ {μ}_{min} \leq {μ}_{t} \leq {μ}_{max} ;$$

$$\\ {ζ}_{min} \leq {ζ}_{in} \leq {ζ}_{max} ;$$

where H represents a frequency response function; i represents an imaginary unit; ω represents a frequency of an external excitation; μₜ represents the tuned mass ratio; and ζᵢₙ represents the damping ratio;
step 4, solving the optimization equation to obtain values of design parameters of the tuned mass ratio μₜ and the damping ratio ζᵢₙ, and deriving and determining a tuned mass, a damping coefficient, an inertance coefficient, a first rigid spring stiffness, and a second rigid spring stiffness based on the two parameters; and
step 5, verifying the obtained design parameters by time-history analysis, and if a control effect meets the requirements, completing the parameter design;
otherwise, adjusting the value ranges of the tuned mass ratio μₜ and the damping ratio ζᵢₙ and repeating steps 3 and 4 until the control effect is met.

By adopting this method, based on the improved fixed-point theory method, the multi-parameter optimization design problem of the RIDTMD is simplified to the optimization problem of two parameters of mass and damping, so that the relevant design parameters of the RIDTMD can be determined accurately and quickly, thereby achieving the optimal vibration control effect of the tuned mass damper inerter on the low-order modes of high-rise structures.

### To Sum Up, the Present Disclosure has the Following Advantages:

When the main structure is subjected to external excitation to generate dynamic response and the frequency of the external excitation is close to the inherent frequency of the structure, the structure resonates and undergoes a large displacement at the location of the natural vibration mode. During the vibration process of the floor slab along with the main structure, the counterweight in the device will deviate from the stationary position and slide on the floor slab. At this time, the counterweight drives the first rigid springs to deform under the constraint of the first guide rod parallel to the sliding direction of the counterweight, and the resultant force of the first rigid springs are transmitted to the damper element and the inerter element arranged in parallel via the first guide rod and thus to the floor slab. This causes the damper element and the inerter element to perform a linear reciprocating motion parallel to the sliding direction of the counterweight. The inerter element generates an inertial force so that the tuned mass can be amplified. The damper element generates a damping force to dissipate energy, thereby achieving the vibration mitigation effect. When the weight of the counterweight, the elastic force applied thereto, and the damping force reach the optimal control parameters, the inherent frequency of the damper element is consistent with the first-order vibration frequency of the high-rise building, thereby achieving the vibration control of the low-order modes of the high-rise structure.

### BRIEF DESCRIPTION OF THE DRAWINGS

FIG. 1 is an overall schematic structural diagram of a tuned mass damper inerter;

FIG. 2 is a schematic diagram of a connection structure of a T-shaped plate, a first guide rod, and a second guide rod in an embodiment;

FIG. 3 is a schematic structural diagram of a second rigid spring assembly of a tuned mass damper inerter;

FIG. 4 is a schematic diagram of a connection structure of first rigid springs, a damper element, and an inerter element;

FIG. 5 is a schematic structural diagram of a counterweight container in an embodiment;

FIG. 6 is a schematic diagram of a connection structure of a baffle plate assembly; and

FIG. 7 is a flowchart of a parameter design method for a tuned mass damper inerter.

### LIST OF REFERENCE NUMERALS

1—baffle plate, 2—angle steel, 3—round tube, 4—clamp, 5—ball screw assembly, 6—flange, 7—magnetorheological damping element, 8—second intermediate plate, 9—first intermediate plate, 10—1—first base plate, 10—2—second base plate, 11—linear round guide rail, 12—second rigid spring, 13—first rigid spring, 14—1—first guide rod, 14—2—second guide rod, 15—T-shaped plate, 16—counterweight container, 17—lifting lug, 18—counterweight guide rail slider mechanism, 19—guide rail embedded part, and 20—bolt.

### DETAILED DESCRIPTION OF THE EMBODIMENTS

The present disclosure will be further described in detail below.

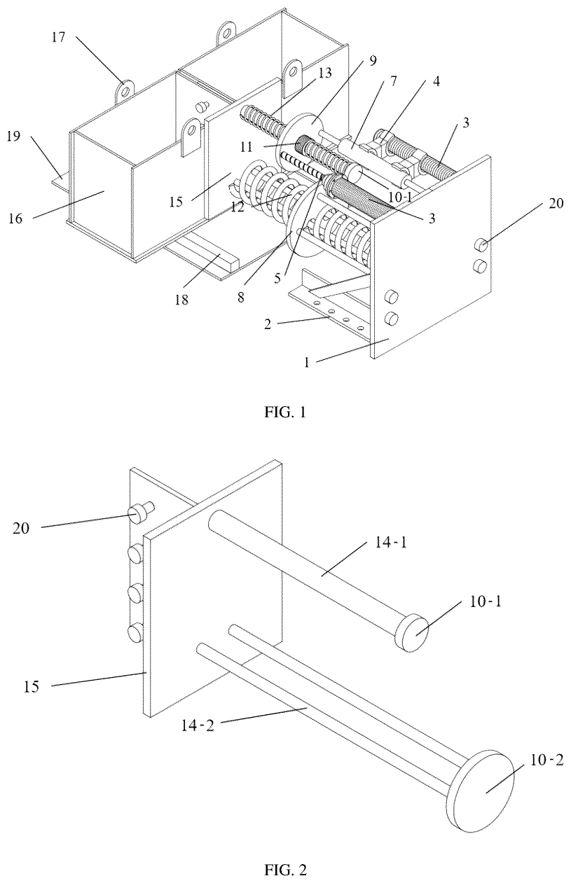

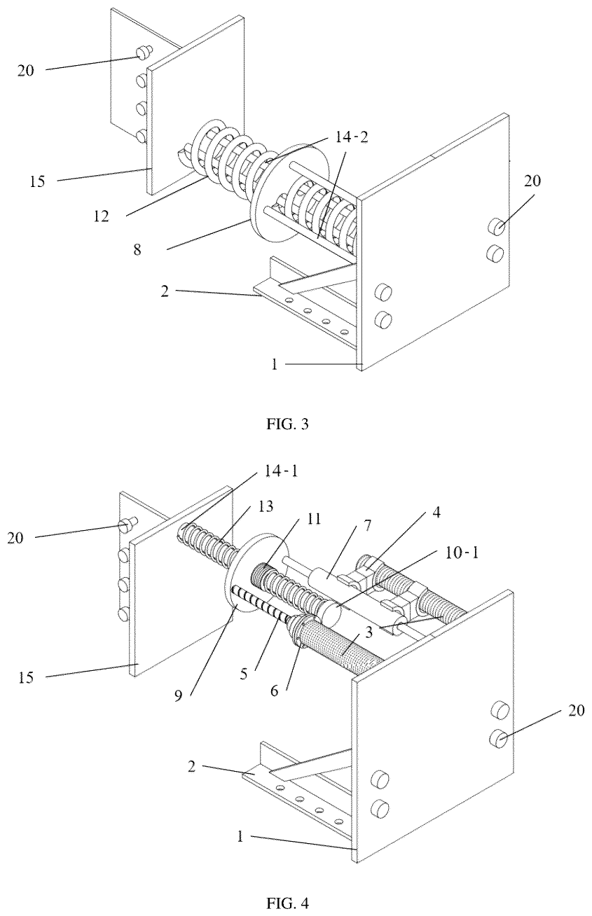

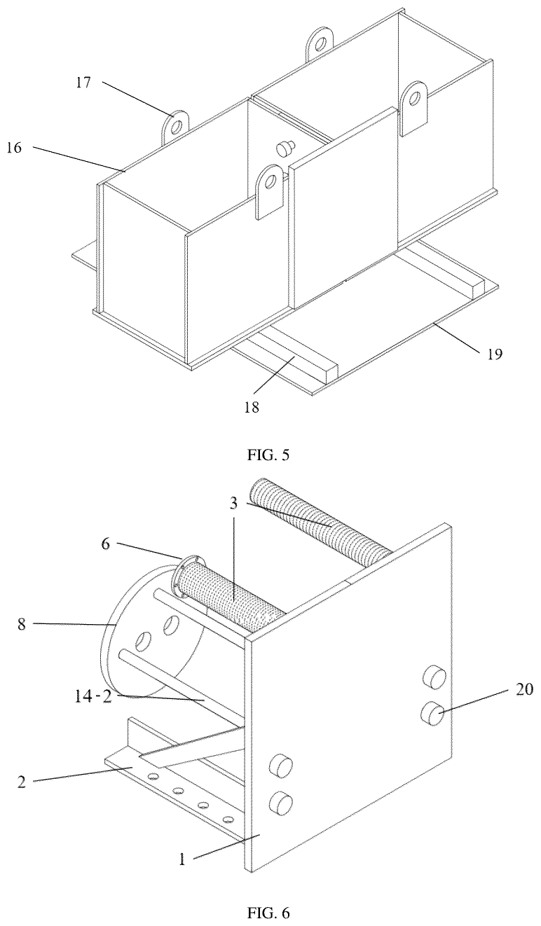

As shown in FIG. 1 to FIG. 6, a tuned mass damper inerter includes a mounting support assembly, a first rigid spring assembly, a second rigid spring assembly for transmitting an axial motion of a structure, an inerter-damper parallel-connected assembly for energy dissipation and tuned mass amplification, a counterweight container assembly, and a T-shaped plate assembly for connecting the mounting support assembly and the counterweight container assembly.

A counterweight container 16 of the counterweight container assembly is configured to accommodate a counterweight. A plurality of square sliders are arranged and mounted at a central position of a lower steel plate of the counterweight container 16. A guide rail embedded part 19 that cooperates with a counterweight guide rail slider mechanism 18 is disposed on a floor slab, and the counterweight container 16 is horizontally and slidably connected to the floor slab via the counterweight guide rail slider mechanism 18. Two first rigid springs 13 of the first rigid spring assembly and two second rigid springs 12 of the second rigid spring assembly are configured to provide an elastic force for the reciprocating motion of the counterweight container 16. The counterweight container 16 is provided with a lifting lug 17 to facilitate lifting.

The mounting support assembly is connected to a floor slab of a building structure. The mounting support assembly includes an angle steel 2, a baffle plate 1, and a round tube 3. The angle steel 2 is connected to the baffle plate 1 via welding or a bolt 20. The angle steel 2 is connected to the main structure of the building via an anchor bolt. The round tube 3 is welded to the baffle plate 1.

A T-shaped plate 15 of the T-shaped plate assembly is perforated, with a hole position corresponding to the counterweight container 16. One side of the T-shaped plate 15 is connected to two counterweight containers 16, and a first guide rod 14-1 and a second guide rod 14-2 are connected to the other side of the T-shaped plate 15 at positions corresponding to the center of the T-shaped plate 15. Two first rigid springs 13 are placed on the first guide rod 14-1, and two second rigid springs 12 are placed on the second guide rod 14-2.

The two first rigid springs are arranged corresponding to the first guide rod 14-1, a first intermediate plate 9, and a first base plate 10-1. One first rigid spring 13 is arranged between the first intermediate plate 9 and the first base plate 10-1. Another first rigid spring 13 is arranged between the first intermediate plate 9 and the counterweight container 16. The first intermediate plate 9 is fixed to the mounting support assembly. The first guide rod 14-1 passes through a hole of the first intermediate plate 9. The first base plate 10-1 is fixedly connected to a tail end of the first guide rod 14-1. The first guide rod 14-1 connected to the T-shaped plate 15 is configured to limit a deformation direction of the first rigid spring 13.

An inerter element of the inerter-damper parallel-connected assembly is realized by a ball screw assembly 5. One end of the ball screw assembly 5 partially passes through the round tube 3. A flange 6 is welded at one end of the round tube 3. The outer surface of a rotating nut of a ball screw element of the ball screw assembly 5 is fixed using the flange 6. The other end of the round tube 3 is connected to the mounting support assembly. A flywheel is mounted on the rotating nut. The rotating nut is in the shape of a stepped cylinder. An enclosed ball track is provided inside the rotating nut and contains balls therein. When the screw is translated, the balls will circularly move in the thread teeth of the screw and within a bearing track, and drive the rotating nut and the flywheel to rotate. The flywheel and the rotating nut are fixedly connected and do not rotate relative to each other. The flywheel has a certain mass and radius, and is disassembled and replaced according to actual needs. The ball screw element is configured to adjust the inertia of the counterweight container 16 by changing the lead of the ball screw assembly and the size of the flywheel.

A damping element of the inerter-damper parallel-connected assembly is realized by a magnetorheological damping element 7, and a damping fluid is an oil-based magnetorheological fluid with electrical conductivity. The cylinder body of the magnetorheological damping element 7 is fixed via a clamp 4, and the other side of the clamp 4 is fixed to the round tube 3 that is connected to the mounting support assembly. The damping magnitude of the magnetorheological damping element 7 may be varied by adjusting the current as needed, so as to provide a suitable adjustable damping force for the linear reciprocating motion of the counterweight container 16.

The other end of the ball screw assembly and the piston rod end of the magnetorheological damping element 7 are both fixed to the first intermediate plate 9 on the linear round guide rail 11, and the first intermediate plate 9 is connected to the linear round guide rail 11 via the flange 6, thereby achieving the parallel connection effect of the inerter-damper parallel-connected assembly.

The first guide rod 14-1 passes through the middle of the linear round guide rail 11 of the inerter-damper parallel-connected assembly. The linear round guide rail 11 may move horizontally along the first guide rod 14-1. The first rigid springs 13 are sleeved over the first guide rod 14-1. The first guide rod 14-1 has one end fixed to the T-shaped plate and the other end fixed to the first base plate 10-1, thereby forming the first rigid spring assembly.

A series-connected assembly is formed between the inerter-damper parallel-connected assembly and the first rigid spring assembly 13, and the series-connected assembly is then connected in parallel to the second rigid spring 12.

The second guide rod 14-2 is disposed on one side of the first guide rod 14-1. Two second rigid springs 12 are sleeved over the second guide rod 14-2. The second intermediate plate 8 is sleeved over the second guide rod 14-2. The second guide rod 14-2 passes through the second intermediate plate 8 and is provided with a second base plate 10-2 at an end thereof. The second rigid springs 12 are arranged between the second intermediate plate 8 and the second base plate 10-2 and between the second intermediate plate 8 and the counterweight container 16.

The sliding direction of the counterweight, the first guide rod 14-1, the second guide rod 14-2, the first rigid springs 13, the second rigid springs 12, the damper element, and the inerter element are parallel to each other.

During use, the tuned mass damper inerter is mounted inside a high-rise structure for controlling, but not limited to, the first-order structural vibration of the structure. When the high-rise structure is subjected to external excitation to generate dynamic response and the frequency of the external excitation is close to the inherent frequency of the structure, the structure resonates and undergoes a large displacement at the location of the natural vibration mode. During the vibration process of the high-rise structure, the counterweight container 16 in the device will deviate from the stationary position and slide in the track. At this time, the counterweight container 16 drives the two rigid springs to deform under the constraint of the guide rods parallel to the direction of the track, and the resultant force of the rigid springs is transmitted to the mounting support assembly via the guide rods. The first rigid springs 13 drive the magnetorheological damping element 7 and the ball screw element to perform a linear reciprocating motion parallel to the track, so that the balls move in the screw and the ball bearing and drive the ball bearing and the flywheel to rotate, generating an inertial force. The magnetorheological damping element 7 can generate the appropriate damping force after being electrified. When the weight of the mass block, the elastic force applied thereto, and the damping force reach the optimal control parameters, the inherent frequency of the damper element is consistent with the first-order vibration frequency of the high-rise building, thereby achieving the vibration control of the low-order modes of the high-rise structure.

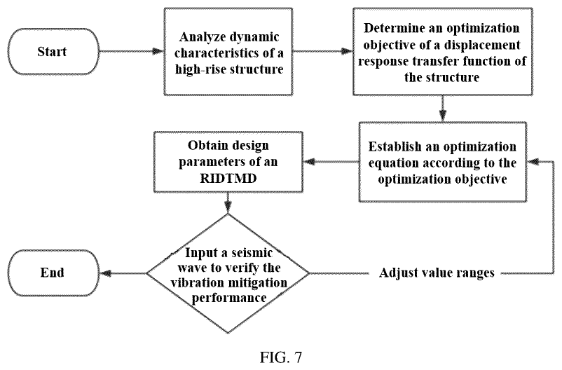

As shown in FIG. 7, a parameter design method for a tuned mass damper inerter includes the following steps.

In step 1, a main structure of a floor slab is pre-analyzed to obtain modal and vibration mode results and determine a mounting position of the tuned mass damper inerter.

In step 2, after the mounting position is determined, a kinematic equation is established, from which a displacement response transfer function of the main structure is derived, and then an optimization equation with the H₂ norm l of the displacement response transfer function of the main structure as an optimization objective is established.

### The Kinematic Equation is Expressed as:

$$\\ {MX}^{″} + {CX}^{′} + KX = - {M}_{R} {X}_{g}^{″} .$$

### The Displacement Response Transfer Function is Expressed as:

$$\\ H ( ω ) = {{C}_{s} ( i ω I - A )}^{- 1} E ;$$

where

$$\\ A = [ \begin{matrix}0 & I \\ - {M}^{- 1} K & - {M}^{- 1} C\end{matrix} ] ; E = [ \begin{matrix}0 \\ - {M}^{- 1} {M}_{R}\end{matrix} ] ;$$

and

$$\\ {C}_{s} = [ \begin{matrix}{l}_{N + 2 n} & {0}_{N + 2 n}\end{matrix} ] ,$$

where I represents a unit matrix; M represents a mass matrix attached with tuned mass and inertance; K represents a stiffness matrix; C represents a damping matrix; M_{R} represents a mass matrix only attached with tuned mass; A represents a state matrix to describe dynamic characteristics of a system; E represents an input matrix to describe the effect of an input on a state; and Cs represents an output matrix to describe the contribution of the state to an output.

In step 3, the optimization objective/is determined according to requirements, and with given value ranges of a tuned mass ratio μₜ and a damping ratio ζᵢₙ, the parameter optimization of the tuned mass damper inerter is achieved via step-by-step parameter scanning, where the tuned mass damper inerter is an RIDTMD;

### The Optimization Equation is Expressed as:

$$\\ l = {‖ H ‖}_{2} = {‖ {{C}_{s} ( i ω - A )}^{- 1} E ‖}_{2} ;$$

$$\\ {μ}_{min} \leq {μ}_{t} \leq {μ}_{max} ;$$

$$\\ {ζ}_{min} \leq {ζ}_{in} \leq {ζ}_{max} ;$$

where H represents a frequency response function; i represents an imaginary unit; ω represents a frequency of an external excitation; μₜ represents the tuned mass ratio; and ζᵢₙ represents the damping ratio.

In step 4, the optimization equation is solved to obtain values of design parameters of the tuned mass ratio μₜ and the damping ratio ζᵢₙ, and a tuned mass, a damping coefficient, an inertance coefficient, a first rigid spring stiffness, and a second rigid spring stiffness are derived and determined based on the two parameters.

In step 5, the obtained design parameters are verified by time-history analysis, and if the control effect meets requirements, the parameter design is completed; otherwise, the value ranges of the tuned mass ratio μₜ and the damping ratio ζᵢₙ are adjusted and steps 3 and 4 are repeated until the control effect is met.

### The Present Disclosure has the Following Advantages:

By leveraging the apparent mass amplification characteristic of the inerter element, the tuned vibration mitigation device can achieve lightweight vibration mitigation.

When the tuned vibration of the counterweight container 16 is induced by the main structure under an external excitation, the parallel-connected assembly of the magnetorheological damping element and the ball screw moves along with the motion of the first rigid springs 13 and produces a resonance effect. In this case, the motion phase of the parallel-connected assembly will be nearly opposite to that of the first rigid springs 13, so that the displacement amplitude of the parallel-connected assembly is greater than that of the counterweight container 16. That is, it is conducive to generating greater damping under a small displacement of the magnetorheological damping element.

The parallel-connected assembly can better achieve the synergistic energy efficiency of the magnetorheological damping element 7 and the tuned mass amplification effect of the ball screw 5, thereby enhancing the control effect of the whole device.

The motion of the counterweight container 16 is transmitted to the damper element and the inerter element via the first intermediate plate 9, and the relevant design of the first intermediate plate 9 and the first rigid springs 13 can play a role of stabilization and buffering, and can make the motion of the first intermediate plate 9 more stable, thereby reducing the impact of the counterweight container 16 on the damper element and the inerter element. The second intermediate plate 8 and the second rigid springs 12 can play a role in making the motion of the counterweight container 16 more stable.

The internal structure of the tuned mass damper inerter is balanced, enabling more stable and reliable responses to external excitation. This enhances the vibration mitigation effect and improves the vibration control of the building structure by the tuned mass damper inerter.

The configuration is simple, which directly corresponds to the mechanical principle diagram, enabling convenient adjustment. The performance parameters of the inerter can be quickly adjusted by adjusting the overall stiffness of the two rigid springs, the lead of the ball screw assembly, the size of the flywheel, the mass of the counterweight, and the current of the magnetorheological damping element 7.

The design method with the H₂ norm l of the displacement response transfer function of the main structure as the optimization objective is adopted for the relevant parameters in the present disclosure. Based on the improved fixed-point theory method, the multi-parameter optimization design problem of the RIDTMD is simplified to the optimization problem of two parameters of mass and damping, so that the relevant design parameters of the RIDTMD can be determined accurately and quickly.

The above embodiments are preferred ones of the present disclosure. However, the embodiments of the present disclosure are not limited by the above embodiments. Any change, modification, substitution, combination, and simplification made without departing from the spiritual essence and principle of the present disclosure should be an equivalent replacement manner, and all are included in the protection scope of the present disclosure

1. A tuned mass damper inerter, comprising: a mounting support assembly, a first rigid spring assembly, a second rigid spring assembly for transmitting an axial motion of a structure, an inerter-damper parallel-connected assembly for energy dissipation and tuned mass amplification, a counterweight container assembly, and a T-shaped plate assembly for connecting the mounting support assembly and the counterweight container assembly;
wherein a counterweight container of the counterweight container assembly is configured to accommodate a counterweight; first rigid springs of the first rigid spring assembly and second rigid springs of the second rigid spring assembly are configured to provide an elastic force for a reciprocating motion of the counterweight container;
the mounting support assembly is connected to a floor slab and comprises an angle steel, a baffle plate, and a round tube; the angle steel is connected to the baffle plate;
the angle steel is configured to be connected to a main structure of a building; the round tube is welded to the baffle plate;
a T-shaped plate of the T-shaped plate assembly is provided with a hole at a position corresponding to the counterweight container; the T-shaped plate is connected to the counterweight container, and a first guide rod and a second guide rod are connected to another side of the T-shaped plate at corresponding central positions; the first rigid springs are placed on the first guide rod, and second rigid springs are placed on the second guide rod;
the first rigid springs are arranged corresponding to the first guide rod, a first intermediate plate, and a first base plate; wherein the first rigid springs are arranged between the first intermediate plate and the first base plate and between the first intermediate plate and the counterweight container; the first intermediate plate is fixed to the mounting support assembly; the first guide rod passes through a hole of the first intermediate plate; the first base plate is fixedly connected to a tail end of the first guide rod;
an inerter element of the inerter-damper parallel-connected assembly is realized by a ball screw assembly; one end of the ball screw assembly partially passes through the round tube; a flange is welded at one end of the round tube; an outer surface of a rotating nut of a ball screw element of the ball screw assembly is fixed by the flange;
anther end of the round tube is connected to the mounting support assembly; a flywheel is mounted on the rotating nut; the ball screw element is configured to adjust an inertia of the counterweight container by changing a lead of the ball screw assembly and a size of the flywheel;
a damping element of the inerter-damper parallel-connected assembly is realized by a magnetorheological damping element, and a damping fluid is an oil-based magnetorheological fluid with electrical conductivity; a cylinder body of the magnetorheological damping element is fixed via a clamp, and another side of the clamp is fixed to the round tube that is connected to the mounting support assembly;
another end of the ball screw assembly and a piston rod end of the magnetorheological damping element are both fixed to the first intermediate plate on a linear round guide rail, and the first intermediate plate is connected to the linear round guide rail via the flange, thereby achieving a parallel connection effect of the inerter-damper parallel-connected assembly;
the first guide rod passes through a middle of the linear round guide rail of the inerter-damper parallel-connected assembly; the linear round guide rail is configured to move horizontally along the first guide rod; the first rigid springs are sleeved over the first guide rod; the first guide rod has one end fixed to the T-shaped plate and another end fixed to the first base plate, thereby forming the first rigid spring assembly;
a series-connected assembly is formed between the inerter-damper parallel-connected assembly and the first rigid spring assembly, and the series-connected assembly is then connected in parallel to the second rigid springs;
the second guide rod is disposed on one side of the first guide rod; the second rigid springs are sleeved over the second guide rod; a second intermediate plate is sleeved over the second guide rod; the second guide rod passes through the second intermediate plate and is provided with a second base plate at an end thereof; the second rigid springs are arranged between the second intermediate plate and the second base plate and between the second intermediate plate and the counterweight container; and
a sliding direction of the counterweight, the first guide rod, the second guide rod, the first rigid springs, the second rigid springs, the damper element, and the inerter element are parallel to each other.

2. The tuned mass damper inerter according to claim 1, wherein the first rigid springs between the first intermediate plate and the counterweight container and between the first intermediate plate and the first base plate are the same in total stiffness, length, and deformation amount; and the second rigid springs between the second intermediate plate and the counterweight container and between the second intermediate plate and the second base plate are the same in total stiffness, length, and deformation amount.
